(19) United States
(12) Patent Application Publication
(10) Pub. No.: US 2010/0083939 A1
(43) Pub. Date: Apr. 8, 2010

(54) Simple device for completely converting diesel fuel into useful energy and little carbon exhaust

(76) Inventors: Leslie G. Hammer, Granby, CT (US); Gabor Nemeth, Vienna (AT)

Correspondence Address: Theodore L. Heying;MGM Instruments Inc., 925 Sherman Ave., Hamden, CT, 06514, US

(21) Appl. No.: 12/589,426

(22) Filed: Oct. 23, 2009

Related U.S. Application Data
(63) Continuation-in-part of application No. 11/977,523, filed on Oct. 24, 2007, now abandoned.

(51) Int. Cl. F02M 27/04; F01N 3/02

(52) U.S. Cl. 123/539; 60/275

(57) ABSTRACT

This invention is for a simple device for converting the oxygen in air to ozone which then passes into the combustion chamber of a diesel fueled engine. When this device is used the amount of energy obtained from the diesel is greatly increased.

Continuation-in-part of application Ser. No. 11/977,523, filed on Oct. 24, 2007 in the name of Leslie G. Hammer

### FIELD OF INVENTION

This invention relates to internal combustion engines and especially to those that consume diesel fuel in operation. In particular this invention relates to another method and device to improve the operating efficiency and control of emissions of such an engine.

### BACKGROUND OF THE INVENTION

It is well known that since the development of the internal combustion engine there has always been a desire to improve their performance by improving the miles per gallon achieved when such engines are used in moving vehicles such as trucks, buses and automobiles. More recently there has been a desire to maintain complete combustion of the diesel fuel and eliminate such unhealthy emissions such as non-combusted fuel and fuel particles, carbon monoxide, nitrogen oxides and ozone when it is used in addition to air to improve the combustion.

Although there have been many advances and patents issued and filed starting with those to use ozone in this respect to address those issues such as U.S. Pat. Nos. 1,333,836 and 1,725,661, which primarily address the efficiency, none have seemed to be commercially viable. More recently U.S. Pat. Nos. 4,434,771, 4,308,844, 5,913,809, 6,305,363, 6,463,919, 7,341,049 as well as applications U.S. 2005/0016507, 2008/0105239, 2009/0095266 and 2009/0120415 have attempted to address both the efficiency and the emissions problems without much success.

For these reasons the following work was undertaken and completed.

### SUMMARY OF THE INVENTION

This invention seeks to provide an arc-free air ionixing ozone generating system for use with diesel fueled engines which overcomes the disadvantages found in the prior art.

The apparatus primarily consists of a larger metal tube in which is supported a cylindrical metallic brush. These two conductive metallic components are alternatively connected to the positive and negative portions of a generator like one which converts the 12 volt direct current of a typical vehicle battery to a 110 volt alternating current output, which in turn increased to as high as 30,000 volts by the high voltage transformer.

This oxygen enrichment generator first contacts a “power on” signal and next is situated between the air input device of a diesel engine and the engine's turbo charger. The incoming air is passed through this operating device where a major portion of the air is enriched by additional oxygen which completely converts a large portion of the diesel fuel into energy by more efficient combustion with little or no repugnant off-gases like carbon monoxide, partially burned fuel, nitrogen oxides or excess ozone.

### BRIEF DESCRIPTION OF THE DRAWINGS

The present invention will be more thoroughly understood from the following descriptions of the ozone production apparatus and its attachment to a diesel engine.

FIG. 1 illustrates a side view of the design of the Ozone Generator itself and its attachment to the diesel engine.

FIG. 2 presents and end view of the Ozone Generator.

FIG. 3 illustrates where the Ozone Generator is placed within the diesel engine to properly promote more complete combustion of the diesel fuel.

FIG. 4 illustrates another positioning arrangement for the Ozone Generator.

### DETAILED DESCRIPTION OF THE INVENTION

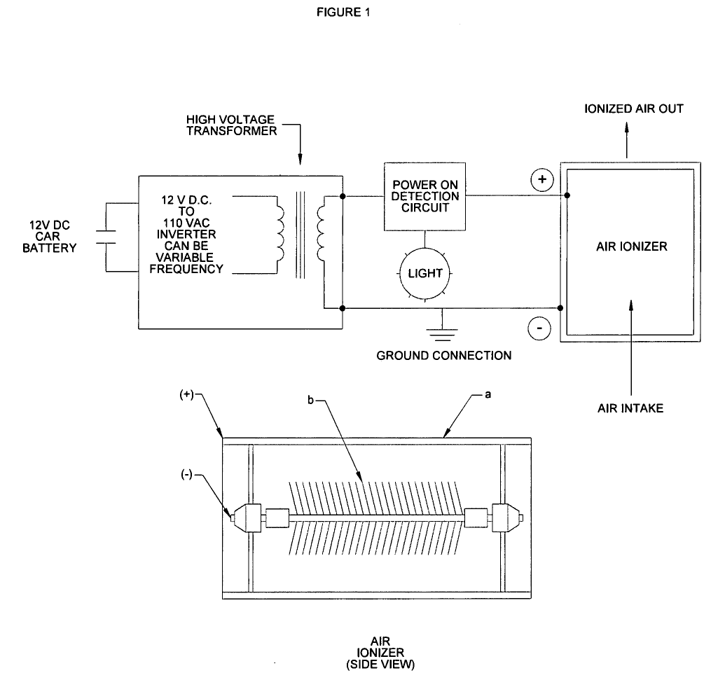

Reference is made to FIG. 1 which shows an outline of an aluminum tube (a) in which is supported a tubular shaped stainless steel brush (b) separately connected to the positive and negative poles of a 12 volt voltage inverter. The inverter in turn is connected to a standard 12 volt automotive battery. A power detection signal is also connected to the poles of the power inverter which signals to the operator that the inverter is working properly.

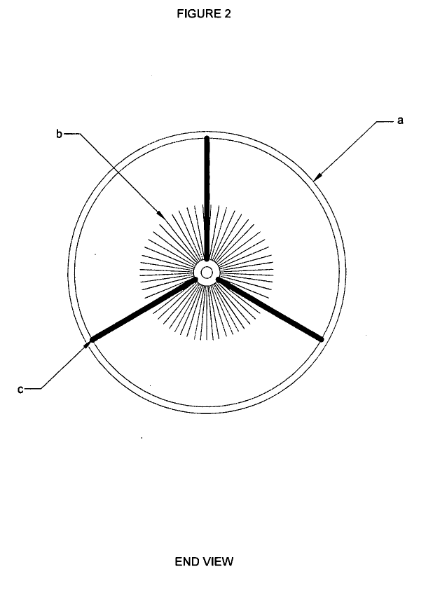

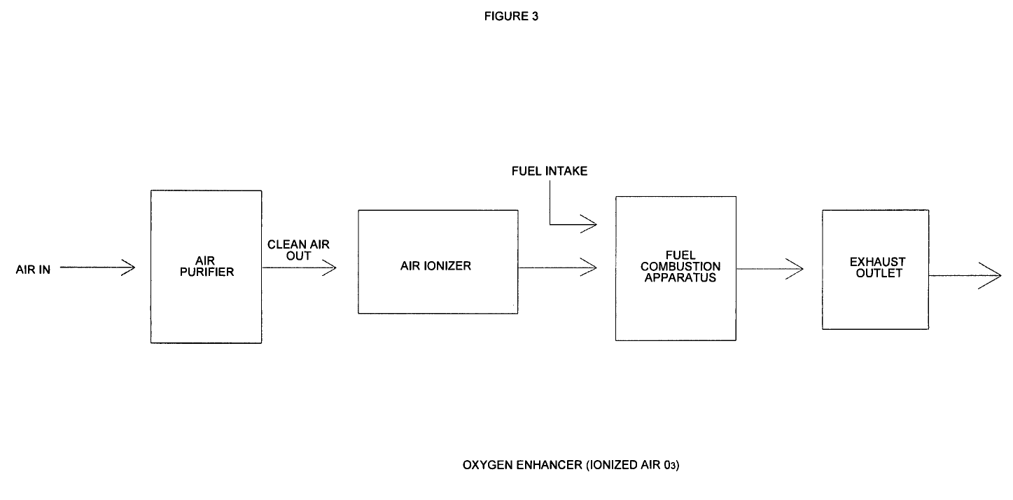

As will be seen in FIG. 2, the wire brush is held in place in the center of the metal tube by several non-conductive, rigid pieces of plastic, in the first embodiment Teflon (c). In this particular embodiment of the invention the metal tube is 8 inches in length, 4 inches in outside diameter and 0.25 inches in thickness. The outside diameter of the wire brush, readily obtained from several commercial sources, is 2 inches. When the power is on and air is flowing from the Air Purifier (see FIG. 3) through the Ozone Generator and into the Fuel Combustion Apparatus a significant portion of the oxygen in the air is converted to ozone resulting in additional oxygen which helps convert most of the diesel fuel into useful energy and carbon dioxide and little if any carbon monoxide and leaving little if any unburned carbon in the exhaust. Those persons skilled in the art will be able to construct an ozone generator of the proper size to suit a given engine size and situation as well as possibly using other proper materials of construction. It is also possible to use several Ozone Generators of the size above in line for larger engines and also to use combinations of these Ozone Generators with those described in U.S. Patent Application 2009/0107112 of which this Application is a Continuation in Part.

FIG. 3 illustrates the proper positioning of the Ozone Generator which is just beyond the air filter or turbocharger so that the filtered air then passes through that Ozone Generator and the ozonized gas then enters directly into the fuel combustion apparatus (engine) and after combustion of the diesel fuel to the exhaust gas treating device which happens to be on the vehicle.

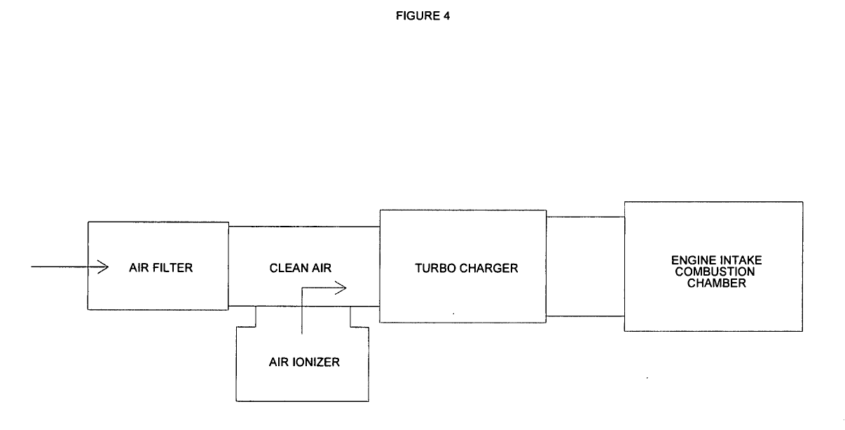

If there is the possibility that some solid particles might enter the Ozone Generator, an arrangement such as the shown in FIG. 4 can be used. Other arrangements are possible.

To demonstrate the usefulness of this device as described above to both improve the combustion and power output of a diesel engine and to show that it positively affects the exhaust composition of a diesel engine, a device in which the tubular shaped wire brush was 8 inches in length was incorporated into the engines of two school buses, one operated by The Truckee Unified School District and the other by Northstar at Tahoe. The School District bus is a 1997, 98 Passenger Bluebird school bus with approximately 155,000 miles on its 3126 Caterpillar Motor. That bus traveled an average of 75 miles per day, five days a week for a total mileage of 700 miles during this test. Before the installation of the ozonator device, that bus averaged 7 miles per gallon. After the installation of the device it averaged 10 miles per gallon is in the 40% increase range.

The California Air Resource Board requires School Districts to perform annual opacity tests on the exhaust of the buses. Before the ozonator device was installed the opacity reading was 2.86% but after the device was installed the opacity reading was 1.42% which was about a 50% decrease in the opacity reading.

The bus of Northstar of California was driven for 210 miles with almost identical results.

As stated above, it will be obvious to persons skilled in the art that the present invention is not limited by the above description of the device and results of its use. The scope of the present invention is defined only by the claims which follow.

We claim:

1. A device for the complete combustion of diesel fuel into useful energy which involves the conversion of the oxygen in normally treated air by:
a. allowing the normally treated air to pass through an electrically conductive tube inside of which is suspended an electrically conductive tubular shaped brush which is held in place in the center of the conductive tube by non-conductive support or supports and b. when a high voltage alternating electric current is applied to the electrically conductive tube and the electrically conductive tubular shaped brush, the oxygen in the air flowing through the conductive tube is converted in a good portion to ozone, and
c. the ozone containing gas is then passed directly into the combustion chamber of a diesel engine wherein the diesel fuel is almost completely converted into useful energy and an exhaust gas which contains little residual carbon.

2. The device in claim 1 wherein the electrically conductive tube is made of a non-oxidizable metal

3. The device in claim 1 wherein the electrically conductive is made of aluminum.

4. The device in claim 1 wherein the bristles of the electrically conductive tubular shaped brush are made of stainless steel.

5. The device in claim 1 wherein the non-conductive support or supports are made of a non-conductive material with high dielectric properties.

6. The device in claim 1 wherein the non-conductive support or supports are made of Lexan.

7. The device in claim 1 wherein the non-conductive support or supports are made of Teflon.

8. The device in claim 1 which is appropriately sized to properly function with the diesel engine to which it is attached.

9. The device in claim 1 wherein to function properly, must be installed directly into the main air stream of the air intake line of the diesel or other internal combustion engine.
